(19) United States
(12) Patent Application Publication
(10) Pub. No.: US 2016/0277872 A1
(43) Pub. Date: Sep. 22, 2016

(54) DOWNSIZED NEAR FIELD COMMUNICATION RING DEVICE

(71) Applicant: Shao-Chieh TING, New Taipei City (TW)

(72) Inventor: Shao-Chieh TING, New Taipei City (TW)

(21) Appl. No.: 14/658,896

(22) Filed: Mar. 16, 2015

(51) Int. Cl. H04W 4/00; H04B 5/00

(52) U.S. Cl. CPC H04W 4/008; H04B 5/0031; H04B 2001/3861

(57) ABSTRACT

A downsized NFC (Near Field Communication) ring device includes a ring body, a NFC module, a decorative sheet and a resin adhesive. The NFC module and a NFC antenna formed by multiple concentric coils in a multilayer stack means are packaged on a substrate, and are closely secured in an accommodating chamber of the ring body. The decorative sheet is adhered and the resin adhesive is filled to provide a securing effect. When the ring body is a metal material, a frequency-enhancing material is disposed between the metal and a printed circuit board to prevent interference, thereby solving the issue of an excessively large width of the ring body caused by the NFC antenna.

### BACKGROUND OF THE INVENTION

a) Field of the Invention

The invention relates in general to a downsized near field communication (NFC) ring device, and more particularly, to a ring device that is adhered and applied to a human body and implements a NFC function through disposing a NFC module. A NFC antenna of the NFC module is packaged on a substrate through multiple concentric coils in a multilayer stack means.

b) Description of the Prior Art

Near field communication (NFC), a non-contact identification and communication technology, is capable of short-distance radio communication among mobile devices, consumer electronics, personal computers, and smart control tools. NFC provides a simple, touch control solution that enables consumers to directly and intuitively exchange information, interview contents and services. Being a new focus of communication technologies, NFC offers preferred features over Bluetooth in many aspects. For example, compared to Bluetooth, NFC has a faster data transmission speed, a higher security, and lower costs and power consumption. With such novel function, many inventors endow NFC with more imaginations, e.g., a NFC ring device that attracts visual attention. A NFC device is regarded as an amazing product that integrates information storage with a cell phone decoder. When a NFC ring device is worn and set, the ring becomes automatically unlocked at the instant it comes into contact with a cell phone, and may further establish an encrypted link with the cell phone. The above features not only protect personal privacy but also provide the consumer's cell phone with better security.

However, a commercial NFC ring is usually made of metal, and a NFC circuit and an antenna coil or a NFC printed circuit board (PCB) are installed between plastic rubber and a ring facet using the decorative plastic rubber. As such, NFC may penetrate through the plastic rubber to emit radio signals by a NFC communication mode. Nonetheless, the above product provides unsatisfactory waterproof effects, and an excessively large width of the ring also lacks ease of use.

Therefore, there is a need for solution that improves the above drawbacks and at the same time provides aesthetical effects and enhanced ease of use.

### SUMMARY OF THE INVENTION

It is a primary object of the present invention to provide a downsized NFC ring device. The downsized NFC ring device includes a ring body, a NFC module, a decorative sheet, and a resin adhesive curable in room temperature. Thus, a downsized NFC ring device is provided to satisfy practical, wearable and aesthetical requirements.

It is a secondary object of the present invention to provide a NFC module having a NFC antenna that is packaged on a substrate through multiple concentric coils in a multilayer stack means. It is another object of the present invention to provide a NFC module and an outer layer of a decorative sheet, between which a resin adhesive (e.g., epoxy) curable in room temperature is filled. The above structure is packaged to satisfy not only functional but also waterproof and aesthetic requirements.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a perspective view of the present invention;

FIG. 2 is an exploded view of the present invention;

FIG. 3 is a circuit diagram of a NFC module of the present invention;

FIG. 4 to FIG. 7 are layout diagrams of respective layers of a NFC module of the present invention;

FIG. 8 is a stacked structure of an antenna of a NFC module of the present invention;

FIG. 9 is a circuit diagram of another NFC module of the present invention;

FIG. 10 to FIG. 13 are layout diagrams of respective layers of another NFC module of the present invention; and

FIG. 14 is a stacked structure of an antenna of another NFC module of the present invention.

### DETAILED DESCRIPTION OF THE PREFERRED EMBODIMENTS

Details and technical contents of the present invention are given below in the non-limiting embodiments in which a coil of a NFC module is implemented by a four-layer means with reference to the accompanying drawings.

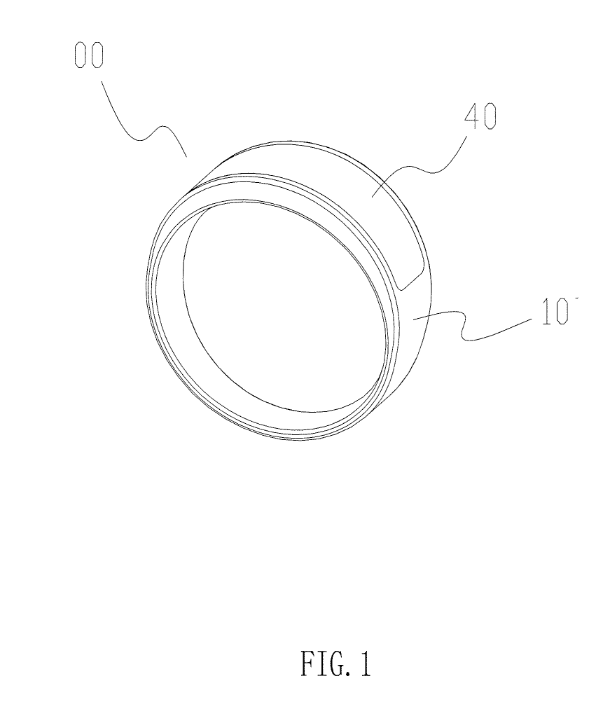

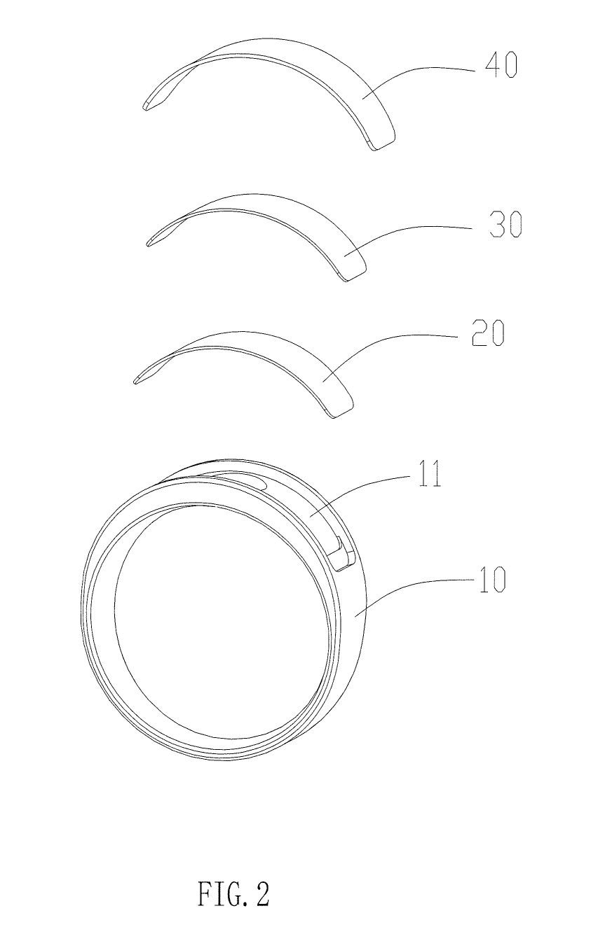

As shown in FIG. 1 and FIG. 2, a design of a downsized near field communication (NFC) ring device 00 mainly includes a ring body 10, a NFC module 20, a decorative sheet 30, and a resin adhesive 40 curable in room temperature. The NFC module 20 can be loaded with multiple NFC application functions.

The ring body 10, adapted to be worn on a finger, has an outer periphery disposed with an accommodating chamber 11 for accommodating the NFC module 20 and the decorative sheet 30 as well as the resin adhesive 40 curable in room temperature, thereby achieving waterproof effects and enhancing aesthetic values.

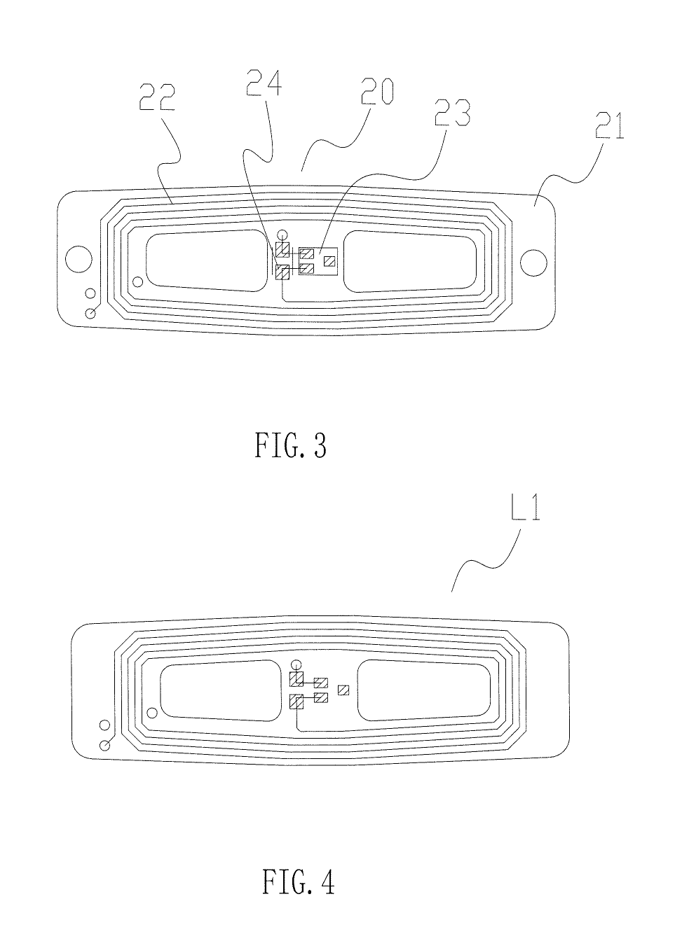

Referring to FIG. 3 showing a circuit diagram of the NFC module 20 of the present invention, an antenna coil 22 is concentrically packaged on a substrate 21. A receiver IC (Integrated Circuit) 23 and a matching capacitor 24 are further disposed on the substrate 21.

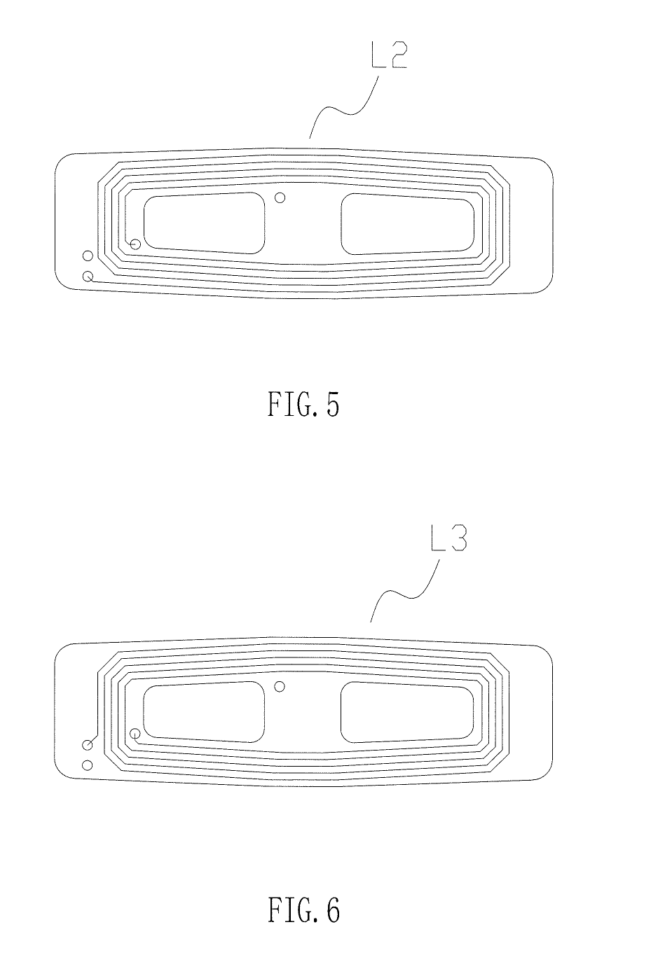

FIG. 4 to FIG. 7 show respective layout diagrams of layers L1 to L4 of the NFC module 20 of the present invention.

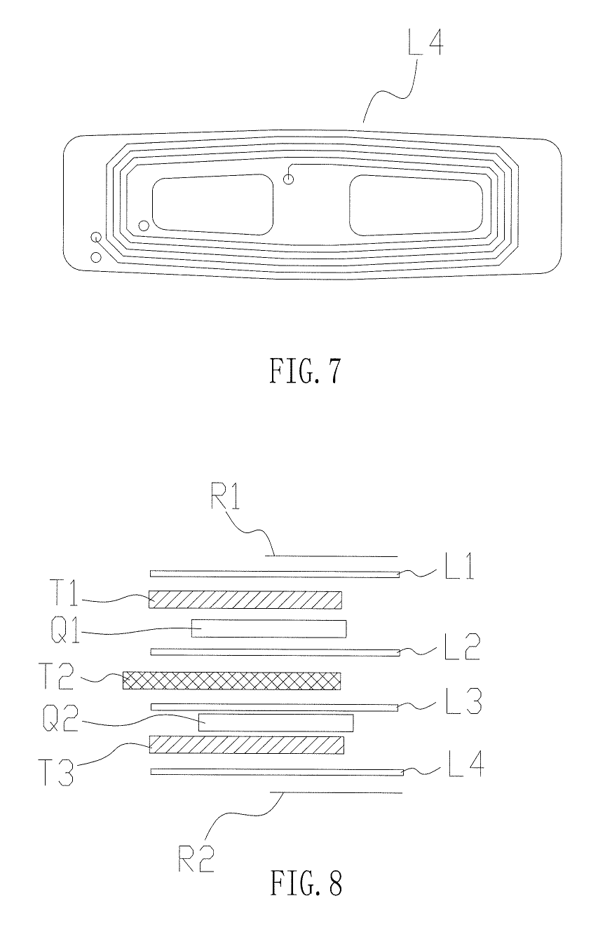

FIG. 8 shows a schematic diagram of a stacked structure of the NFC module of the present invention. From top to bottom, the stacked materials are sequentially a retardant film R1, a first layer L1, a PI (Polyimide film) film T1, an adhesive sheet Q1, a second layer L2, a PI film T2, a third layer L3, an adhesive layer Q2, a PI film T3, a fourth layer L4 and a retardant layer R2. Through the multilayer stack of multiple coils, an object of good near field signal transceiving effects is achieved.

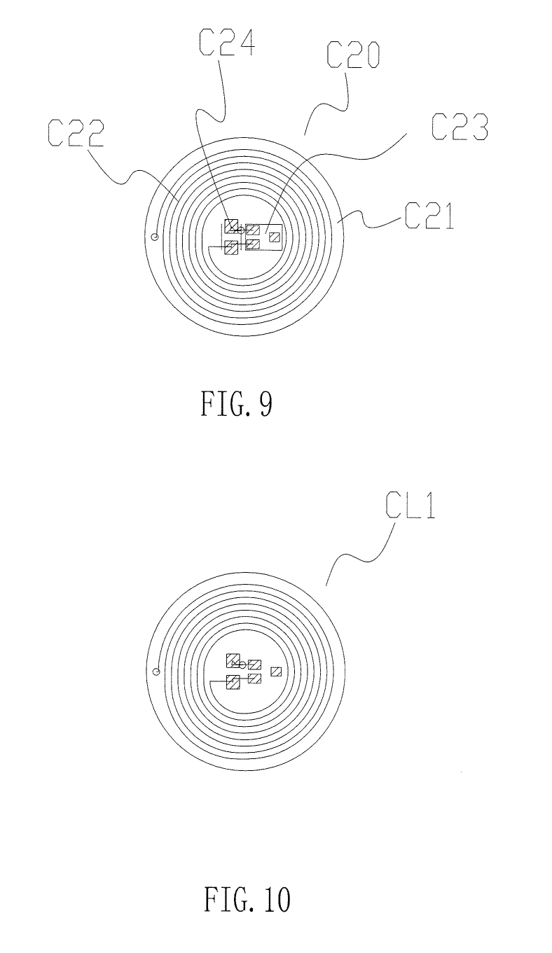

FIG. 9 shows a circuit diagram of another NFC module C20 of the present invention. A coil C22 is concentrically packaged on a substrate C21. On the substrate C21, a receiver IC (Integrated Circuit) C23 and matching capacitor C24 are further disposed. Given that practical and aesthetic requirements are satisfied within a tolerable range of the ring width, the substrate material of the NFC module C20 can be more versatile through shape variations of the NFC module.

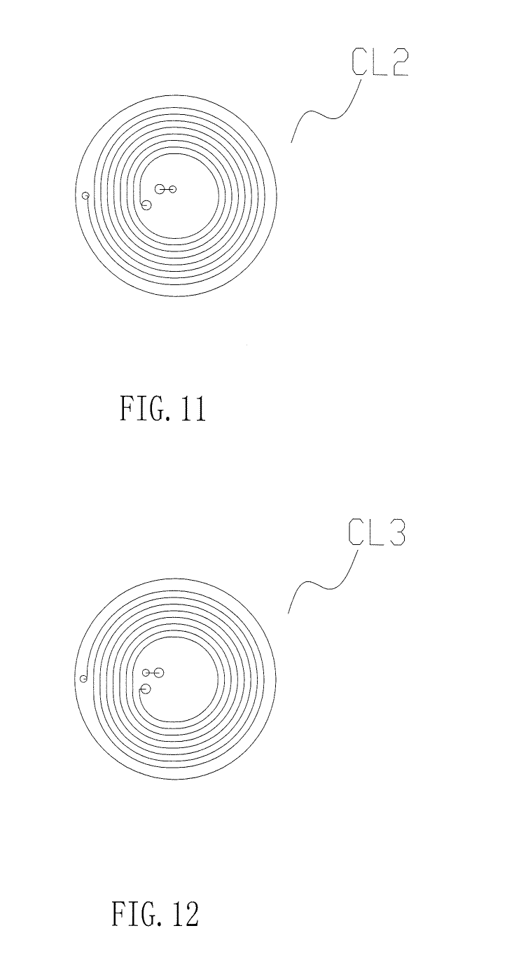

FIG. 10 to FIG. 13 show layout diagrams of respective layers CL1 to CL4 of another NFC module C20.

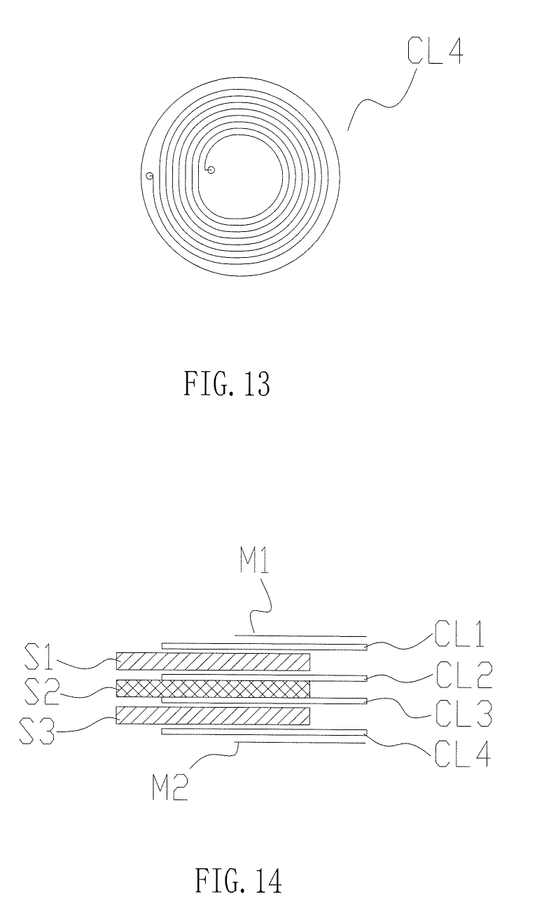

FIG. 14 shows a schematic diagram of a stacked structure of another NFC module C20 of the present invention. From top to bottom, the stacked materials are sequentially a green paint M1, a first layer CL1, a semi-cured sheet S1, a second layer CL2, a copper-clad laminate (CCL) S2, a third layer CL3, a CCL S3, a fourth layer CL4 and a green paint M2.

In conclusion, the present invention provides a design of a downsized NFC ring device that satisfies not only functional but also waterproof and aesthetic requirements.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A downsized Near Field Communication (NFC) ring device, comprising:
a ring body, having an outer periphery disposed with an accommodating chamber for accommodating a NFC module and a decorative sheet and securing a resin adhesive; wherein the NFC module is provided with an antenna and a substrate; wherein the resin adhesive is curable in room temperature and filled into the accommodating chamber to secure the NFC module and the decorative sheet to achieve securing and waterproof effects.

2. The downsized Near Field Communication device according to claim 1, wherein the NFC antenna is packaged on the substrate through multiple coils in a multilayer stack.

3. The downsized Near Field Communication device according to claim 1, wherein the NFC module is loaded with multiple NFC application functions.

4. The downsized Near Field Communication device according to claim 2, wherein the NFC module is loaded with multiple NFC application functions.

5. The downsized Near Field Communication device according to claim 1, wherein the NFC module and the outer periphery of the decorative sheet are capable of curing the resin adhesive package to achieve waterproof and aesthetic effects of the ring body.
